(19) United States
(12) Patent Application Publication
(10) Pub. No.: US 2017/0372345 A1
(43) Pub. Date: Dec. 28, 2017

(54) SYSTEM FOR DETERMINING COMMUNICATION FOR FUTURE OPPORTUNITY

(71) Applicant: Vishwanath Shastry, San Francisco, CA (US)

(72) Inventor: Vishwanath Shastry, San Francisco, CA (US)

(21) Appl. No.: 15/189,137

(22) Filed: Jun. 22, 2016

(51) Int. Cl. G06Q 30/02; G06Q 20/10; H04W 4/12

(52) U.S. Cl. CPC G06Q 30/0239; H04W 4/12; G06Q 20/102; G06Q 30/0211

(57) ABSTRACT

The disclosed system and method use specific computer based components to deliver communications determined by an algorithm to be effective to users based on previously accumulated data where the communication is targeted to a user for a future purchase at a different location.

### BACKGROUND

Marketers have long attempted to create and design electronic systems to promote additional purchases based on previous purchases. Systems have become more and more complex but the end result has not dramatically improved. In addition, consumers have become increasingly careful about providing personal information which could be used to create more personal communications. Finally, there have been some unscrupulous people that have been using offers as a manner to delivered unwanted computer executable applications such as malware.

### SUMMARY

The disclosed system and method use specific computer based components to deliver communications determined by an algorithm to be effective to users based on previously accumulated data where the communication is targeted to a user for a future purchase at a different location. The algorithm reviews vast amounts of data in an attempt to uncover items which are first purchased at a first location type such as a brick and mortar store and then identify purchased that are made at a later time at a second store type such as an online store. Further, the technology necessary to address the technological problem of processing so much data to find the obscure links is disclosed.

### BRIEF DESCRIPTION OF THE DRAWINGS

The invention may be better understood by reference to the detailed description when considered in connection with the accompanying drawings. The components in the figures are not necessarily to scale, emphasis instead being placed upon illustrating the principles of the invention. In the figures, like reference numerals designate corresponding parts throughout the different views.

FIG. 1 is an illustration of the elements of an embodiment of a system for collecting purchase data as shown and described herein;

FIG. 2 is an illustration of a computerized method of collecting purchase data from a first merchant form, analyzing the data and determining an offer at a second merchant form as shown and described herein;

FIG. 3 is an illustration of a method of determining appropriate offers as shown and described herein;

FIG. 4 is an illustration of a portable computing device;

FIG. 5 is an illustration of a server computing device;

FIG. 6 is an illustration of a computerized method of collecting purchase data from a first merchant form, analyzing the data and determining an offer at a second merchant form and feedback the result of the offer as shown and described herein;

FIG. 7 is an illustration of a computerized method of collecting purchase data from a first merchant form, analyzing the data and determining an offer at a second merchant form using a payment system and feeding back the results of the offer as shown and described herein;

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meanings have otherwise been set forth herein.

### SPECIFICATION

The present invention now will be described more fully with reference to the accompanying drawings, which form a part hereof, and which show, by way of illustration, specific exemplary embodiments by which the invention may be practiced. These illustrations and exemplary embodiments are presented with the understanding that the present disclosure is an exemplification of the principles of one or more inventions and is not intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. The following detailed description is, therefore, not to be taken in a limiting sense.

Marketers and merchants have long attempted to create and design electronic systems to promote additional purchases based on previous purchases. Systems have become more and more complex but the end result has not dramatically improved. In addition, consumers have become increasingly careful about providing personal information which could be used to create more personal communications and offers. Finally, there have been some unscrupulous people that have been using offers as a manner to delivered unwanted computer executable applications such as malware.

The disclosed system and method use specific computer based components as a technological solution to deliver communications determined by an algorithm to be effective to users based on previously accumulated data where the communication is targeted to a user for a future purchase at a different location. The amount of purchase data is so large that normal computer equipment may not be capable of handling it. Further, as the amount of data is so large, the algorithms to analyze and make decisions based on the data may also have to be custom designed to not overtax traditional hardware and to take advantage of the custom built hardware to enable the system.

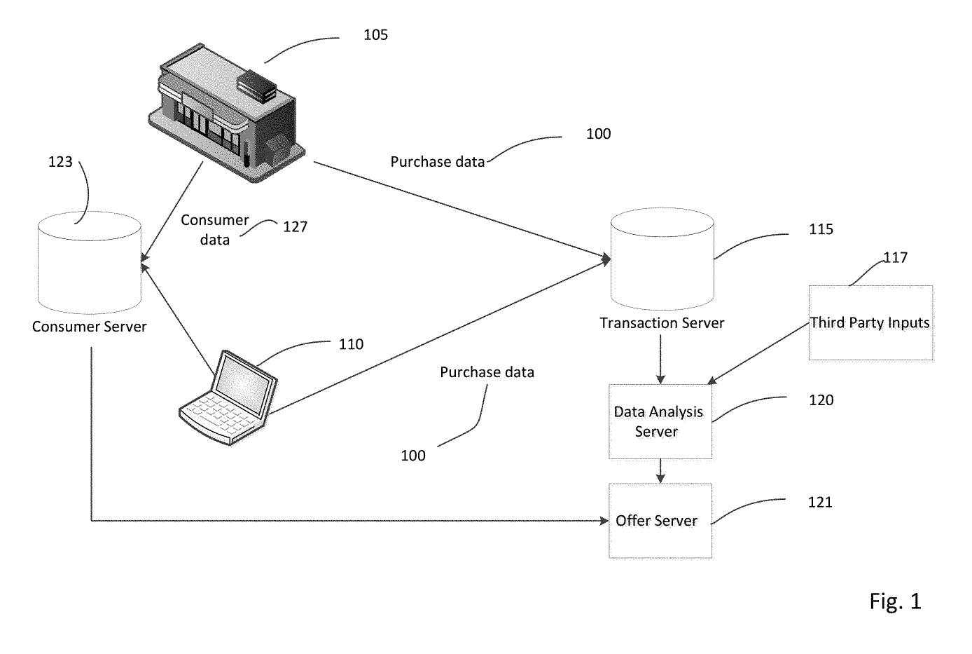

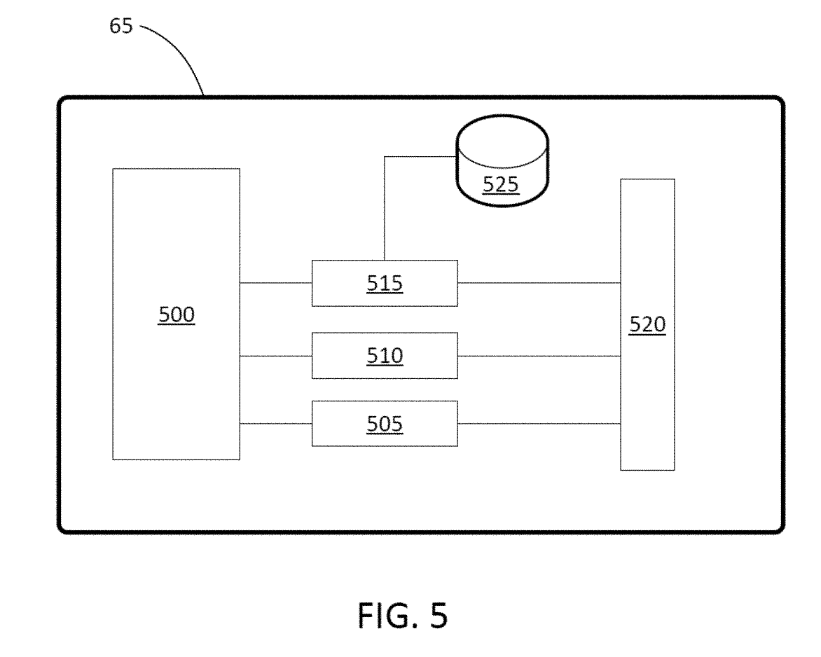

Referring to FIG. 1, a computer system is disclosed which may have several servers which may be physically configured to assist in analysis and decision making of the process. FIG. 5 may illustrate a sample server 65. The server may have a processor 500, an input-output circuit 505, a memory 515, a database 525, device and wireless communication capabilities. The database 525 for digitally storing structured data may be stored in the memory 510 or 515 or may be separate. The database 525 may also be part of a cloud of servers and may be stored in a distributed manner across a plurality of servers. There also may be an input/output bus 520 that shuttles data to and from the various user input devices such as a microphone, a camera, a display monitor or screen, etc. The sample server may be adapted to be any of the servers described in this process although each server may be specially designed to be more efficient for each task.

Referring again to FIGS. 1-3 and 6-7, the transaction server 115 may receive purchase data 100 from a purchase application operating at least two different merchants 105 through a payment network. The transaction server 115 may be purposefully designed to receive and store an enormous amount of data at high speed while still being computationally efficient and conserving power. For example, the transaction server 115 may be a plurality of servers that work together to receive and store the vast quantities of data that may be communicated.

The purchase data 110 may include a variety of data. As some examples and not limitations, the purchase data 110 may include a good or a service purchased, a price paid for the good or the service, a quantity of the good or the service purchased, a time of the purchase, a location of the purchase, the merchant selling the good or the service, and an indication of the purchaser of the good or service. In some embodiments, all of the above listed data is included in the purchase data 110. In other embodiments, not all the above listed data is included.

Other data may also be included in the purchase data 110. In some embodiments, a point of sale device may be used and the point of sale device may have identification data such as a MAC address or an IP address and the identification data may be included as part of the purchase data 100. In other embodiments, a separate computing device may be used such as a laptop, a desktop computer or a mobile computing device. The various computing devices also may have identification data such as a MAC address, an IP address, a serial number, an IMEI reference, an ICCID, an MEID, an SEID, a processor identification number, etc., and the identification data may be included as part of the purchase data 100. The identification data may be used by the system to determine if the transaction is fraudulent or is trusted.

In addition, a consumer server 123 may be present. The consumer server 123 may receive purchase data 100 from the purchase application for at least two consumers. The consumer server 123 may be similar to the transaction server 115 but there are some differences, specifically, the transaction server 115 may receive transaction data 100 from merchants 105 and the consumer server 123 may receive data 127 from consumers. There may be some overlap of the data as a consumer 127 that report data may shop at a merchant that reports data in which case there should be an overlap of the data. In contrast, if the consumer shops at a merchant 105 that does not report transaction data, such as from a store that only accepts cash, there may not be an overlap of the merchant data 100 and the consumer data 127 in the consumer server 123.

The consumer data 127 may contain a variety of data. As some examples and not limitations, the consumer data 127 may include a good or a service purchased, a price paid for the good or the service, a quantity of the good or the service purchased, a time of the purchase, a location of the purchase, the merchant selling the good or the service, and an indication of the purchaser of the good or service. In some embodiments, all of the above listed data is included in the consumer data 127. In other embodiments, not all the above listed data is included.

Other data may also be included in the consumer data 127. In some embodiments, a point of sale device may be used and the point of sale device may have identification data such as a MAC address or an IP address and the identification data may be included as part of the transaction data. In other embodiments, a separate computing device may be used such as a laptop, a desktop computer or a mobile computing device. The various computing devices also may have identification data such as a MAC address, an IP address, a serial number, an IMEI reference, an ICCID, an MEID, an SEID, a processor identification number, etc., and the identification data may be included as part of the transaction data. The identification data may be used by the system to determine if the transaction is fraudulent or is trusted.

The purchase application may accept a plurality of payment devices. For example, the purchase device may include, but not be limited to, a credit card, a debit card, a checking account, a brokerage account, a reward points account, etc. When a user is authorized, any of the payment devices may be used to complete a purchase.

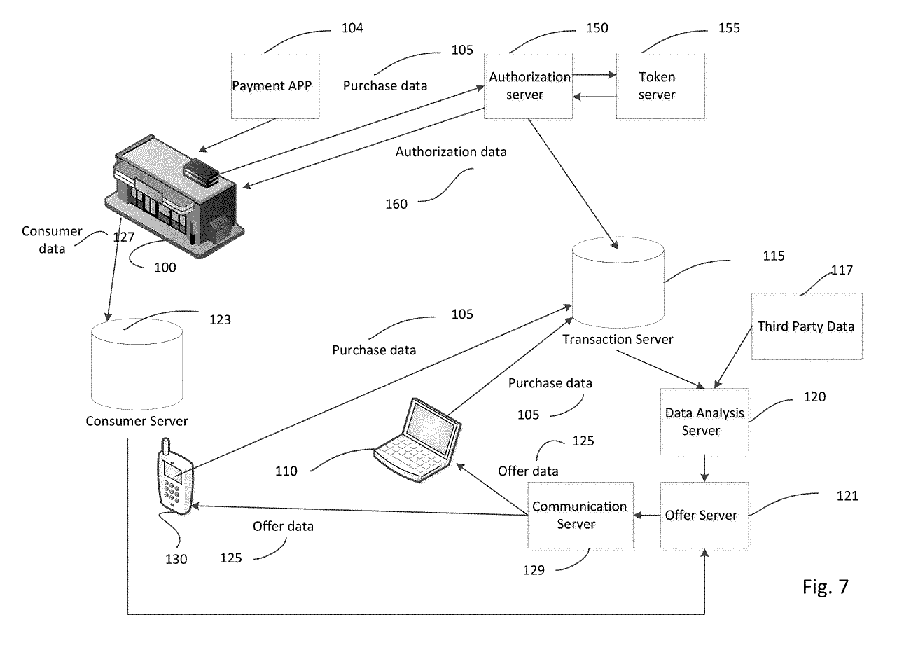

Further, the payment device may use a token based system to add additional security. As illustrated in FIG. 7, in a token based system, an actual personal account number (PAN) may not be communicated from the payment application. A token may be communicated and the contents of the token may be verified by a token server 155. In this way, the PAN of a user may be kept private but a transaction still may occur as the token, which represents the PAN, is verified rather than verifying the actual PAN.

An analysis server 120 may be part of the system. The analysis server 120 may review merchant data 105 and consumer purchase data 127 according to a learning analysis algorithm to determine purchase patterns across the merchants and across the individual. The algorithm may take on a variety of forms. At a high level, the individual data and merchant data may be studied independently and together to determine purchase patterns and purchase links.

Third party inputs 117 may also be submitted to the analysis server 120. The third party inputs 117 may include previous transactions from similar customers, demographics data from third party data sources, credit bureau type data, data from other data collectors and other data sources. Many, many web sites and networks collect data on users. These web sites and networks may be a useful source of additional data. In addition, other sites may aggregate data from a plurality of web sites and/or networks and may create a single source of a large amount of data which may be useful to the analysis server 120.

As an example, a consumer may purchase a birthday cake. Logically, by analyzing the data, the analysis server may determine that a consumer often buys birthday candles along with a birthday cake. In addition, the analysis server 115 may determine what products are purchased a time period that follows the birthday cake and candle purchase. As an example, the consumer may purchase ice cream in a time period after the birthday cake and candle purchase as ice cream may logically be served with day old birthday cake. Similarly, carpet cleaner may be purchased in a future time period as birthday cake often is spilled and carpets need to be cleaned. The connection between birthday cake and carpet cleaner may be uncovered through the analysis server 115.

In a further example, a first purchase (birthday cake) may be located in both consumer 127 and merchant transactions 105. The purchase transactions involving the first purchase (birthday cake) may then be isolated into a group to be analyzed. The group may then be indexed to determine items that are immediately purchased along with the first item. In addition, the transactions of consumers in the future may be analyzed to determine if there is a second item that if often purchased after the first item. For example, the first consumer may purchase a birthday cake at a store and the next day may purchase a computer online. The analysis server 120 may be physically configured to search for other instance where consumers purchased a birthday cake and then purchased a computer shortly thereafter. If few examples are found, the correlation of birthday cakes and later purchases of computers may be low.

In contrast, there may be a higher correlation of purchasing birthday cakes and then purchasing carpet cleaner. By examining the merchant 105 and consumer data 127, a first example of a correlation between purchases (birthday cake and carpet cleaner) may be proven to be high and a second example of a correlation between purchase may be proven to be low (birthday cake and personal computer).

The analysis server 120 may iterate through a large number of potential correlations before determining the best correlations. The correlations may be first accomplished for specific individuals and then for merchants or may be accomplished for merchants and then for individuals. A more robust and useful correlation may be determined by studying but individual behavior and behavior at merchants.

In addition, the algorithm may use a weighting scheme to further enhance the performance of the model and the server. In an example and not limitation, in one embodiment the model may weight more recent transactions more heavily than transactions that occurred in the distant past. In this way, the analysis server 120 may account for trends that may quickly be important but may then fade away in importance.

Logically, from the above description, it may be clear that a machine learning algorithm may be used as part of the process. A first set of data may be used to train the algorithm and server and additional sets of data may be used to test the algorithm. In addition, the training set may be varied and the testing set may be varied to ensure consistent results.

As can be imagined, there may be a very large amount of data that may be reviewed. For example, modern credit card issuers reviewing over 6,000 transactions per second and that number may be rising. Logically, the hardware needed to review so many transactions is very specialized and addresses some very technical problems with technical solutions.

The analysis server 120 made be adapted to handle the large amount of data that may existed related to the merchant transaction data 105 and the consumer transaction data 127. The analysis server 120 may be physically configured to execute one or more algorithms to analyze the merchant transaction data 105 and the customer merchant transaction data 127.

The point of studying large amounts of data on transactions may be to uncover patterns that may not be readily apparent but could be beneficial to the consumers, retailers and merchants. By using special technology, the large amount of data that was previously unreviewable due to its size may now be review and useful, tangible results may be found.

An offer server 121 may also be part of the system to determine which offers to serve to consumers. In some embodiments, the offer server is a separate server and in other embodiments, the offer server may be combined with the data analysis server 120. The offer server 121 may match available offers to the determined purchase patterns to find determined offers. Again, the offer server 121 may be physically configured according to an algorithm to perform the offer review.

The offers may be based on the analysis server 120. The analysis server 120 may determine that two goods are often purchased within a given time frame with a first good purchased at a store and a second good purchased later at home. Thus, it would be valuable to know a user purchased a first item and provide them an offer to a second item where the second offer may be used at home at a later time. The analysis server 120 may provide items with a desired high correlation and the offer server 121 may determine appropriate offers related to the items.

The offer database 121 may contain a plurality of offers and the appropriate offers may be matched to the appropriate goods or services. For example, if users often buy carpet cleaner online shortly after buying birthday cake, users that buy birthday cake may be presented with a couple at purchase to buy carpet cleaner at a later time using a different mode of purchase. Unlike an offer that must be used immediately or in the same mode, the offer may be used later in a different purchase mode.

Further, the offer server 121 and offer database may track the success of offers and may adjust offers 125 based on the success or failure. For example, a $0.05 off coupon on carpet cleaner may not result in many additional sales. However, a $5.00 off coupon may results in many additional sales. The offer server 121 may be physically configured to determine the amount of discount that results in the desire increase in sales and the desired revenue.

In operation, the offer server 121 may create a first offer 125 and track the progress of the offer. In some situations, the offer 125 may be unexpectedly successful such that the manufacturer may lose money on the offer. Logically, a future offer may be less generous.

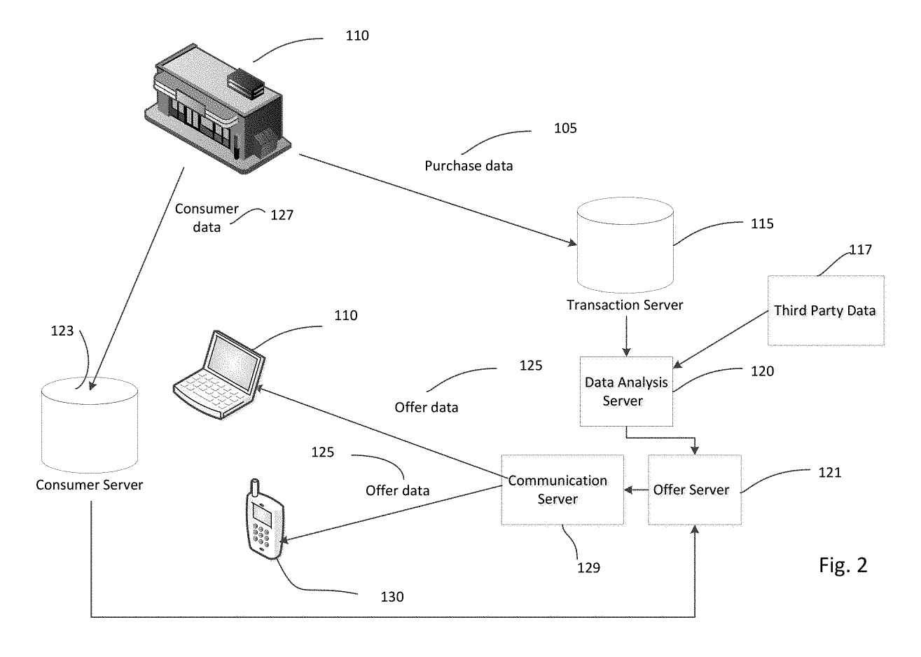

Referring to FIG. 2, a communication server 129 which communicates the determined offers 125 to a consumer after the consumer has completed a transaction wherein the offers are useable at a physical location or through an e-commerce sale at a point in the future. Unlike many offers which may be useful at a current point of sale, the present system may be focused on creating offers which can be used in the future at a different location or even using a different manner of shopping. As an example and not a limitation, a user may make a purchase at a brick and mortar store. Once at home, the communication server may communicate the determined offer for the consumer to use for an online purchase. Logically, if the user first made a purchase online, the offer may be for a brick and mortar store and vice versa as long as the algorithm determines that there is a correlation between the online purchase and the offer for the brick and mortar offer.

The communication may occur in a variety of ways. In some embodiments, the communication address is a mobile device and the offer is communicated by a text message or SMS message. In other embodiments, the offer may be a computer link to a discount such as a link received via email. The manner of communication may be selected by a user. In another embodiment, if the communication server 129 knows the consumer has a particular Twitter handle, the system may target an ad at that user if the a previous transaction by the user did not involve Twitter. The ability to move and communicate across platforms is possible and is contemplated.

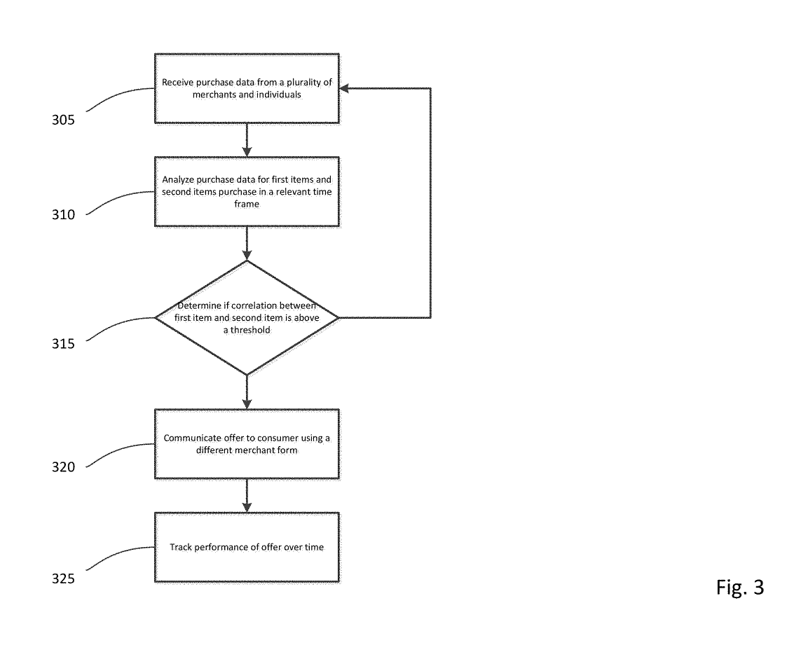

FIG. 3 may illustrate a method that implements the technical details of FIGS. 1, 2, 6 and 7. At block 305, purchase data 105 may be received from a plurality of merchant and individuals as previously described. At block 310, the purchase data 305 may be analyzed by an analysis server 120. The analysis server 120 may test correlation of first items purchased and subsequent items purchased across individuals and merchants. At block 315, the method may determine if the correlation between the first items purchased and subsequent items is high enough to be above a threshold. The threshold may be set in a variety of ways. In one embodiment, the threshold may be set by a user or by an authority.

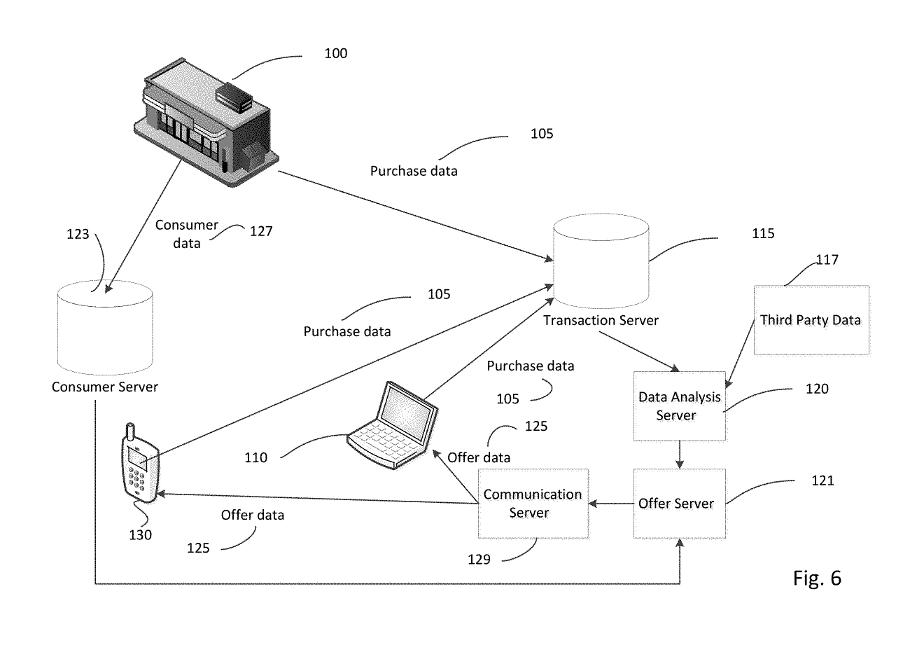

In another embodiment such as in FIG. 6, feedback from the offer related sales may be used to determine an appropriate threshold. If the correlation is not above the threshold, the method may return to block 305 and begin the analysis with a different first good and subsequent goods. At block 320, an offer using a different merchant form may be communicated to the consumer. For example, a brick and mortar sale may result in an online offer and vice versa. At block 325, the performance of the offer over time may be tracked. For example, the offer may increase over time as word spreads of the offer. In contrast, users may tire of the offer and sales may fall over time. The tracking may determine if offer is working as desire or if the offer is becoming slate, ineffective, too expensive, etc.

FIG. 7 may present a situation where a payment application 104 which uses tokens is used to make a first purchase. Tokens may represent an actual personal account number (PAN) but may only be related to the PAN through a token server 155. The token may be presented for payment and the token may travel to an authorization server 150 which may recognize the PAN as being a token. The token may be passed to the token server 155 which may verify the token and endure the property account is charged with the transaction. Assuming the token is recognized, past purchases for the user may be analyzed to search for related payments. If the token is authorized by the token server 155, the authorization server 150 may report a successful authorization to the merchant. If the token is not recognized or the transaction is not authorized, the transaction may not be reported to the transaction server 115. Security may be the advantage of the token and speed for token payments has been increased while maintaining the desired security.

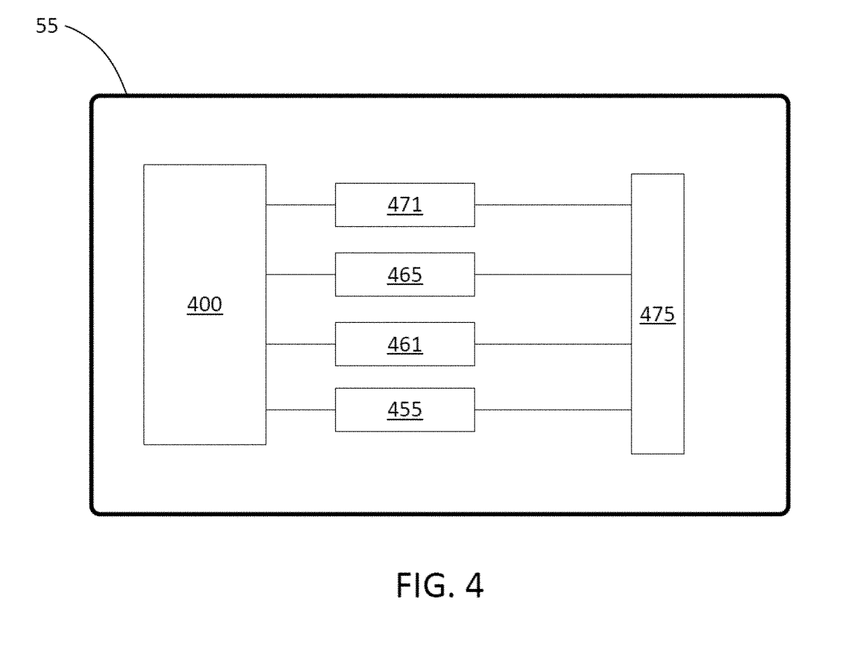

FIG. 4 is a simplified illustration of the physical elements that make up an embodiment of a computing device 55 and FIG. 5 is a simplified illustration of the physical elements that make up an embodiment of a server type computing device, such as the preference server 33, but the various servers may reflect similar physical elements in some embodiments.

Referring to FIG. 4, a sample portable computing device 55 is illustrated that is physically configured according to be part of the computing system 50 shown in FIG. 1. The portable computing device 55 may be similar to portable computing device 130 and may have a processor 451 that is physically configured according to computer executable instructions. In some embodiments, the processor can be specially designed or configured to optimize communication between the server 65 and the computing device 55 relating to the preference application system discussed herein. The computing device 55 may have a portable power supply 455 such as a battery which may be rechargeable. It may also have a sound and video module 461 which assists in displaying video and sound and may turn off when not in use to conserve power and battery life. The computing device 55 may also have volatile memory 465 and non-volatile memory 471. The computing device 55 may have GPS capabilities that may be a separate circuit or may be part of the processor 451. There also may be an input/output bus 475 that shuttles data to and from the various user input/output devices such as a microphone, the camera 108, a display 102, or other input/output devices. The portable computing device 101 also may control communicating with the networks, either through wireless or wired devices. Of course, this is just one embodiment of the portable computing device 101 and the number and types of portable computing devices 101 is limited only by the imagination.

The physical elements that make up an embodiment of a server, such as the transaction server 115, data analysis server 120, offer server 121 or communication server 129 may be further illustrated in FIG. 5. At a high level, the server 65 may include a digital storage such as a magnetic disk, an optical disk, flash storage, non-volatile storage, etc. Structured data may be stored in the digital storage such as in a database. More specifically, the server 65 may have a processor 500 that is physically configured according to computer executable instructions. In some embodiments, the processor 500 can be specially designed or configured to optimize communication between a portable computing device, such as computing device 55 or 130, and the server 65 relating to the e-commerce enabler application and reward points incentive system as described herein. The server 65 may also have a sound and video module 505 which assists in displaying video and sound and may turn off when not in use to conserve power and battery life. The server 65 may also have volatile memory 510 and non-volatile memory 315.

A database 525 for digitally storing structured data may be stored in the memory 510 or 515 or may be separate. The database 525 may also be part of a cloud of servers and may be stored in a distributed manner across a plurality of servers. There also may be an input/output bus 520 that shuttles data to and from the various user input devices such as a microphone, a camera, a display monitor or screen, etc. The input/output bus 520 also may control communicating with the networks, such as communication network 60 and payment network 75, either through wireless or wired devices. In some embodiments, the e-commerce software application running the preference engine may be located on the computing device 55. However, in other embodiments, the application may be located on e-commerce server 55, or both the computing device and the server 65. Of course, this is just one embodiment of the e-commerce server 65 and additional types of servers are contemplated herein.

The user devices, computers and servers described herein may be general purpose computers that may have, among other elements, a microprocessor (such as from the Intel Corporation, AMD or Motorola); volatile and non-volatile memory; one or more mass storage devices (i.e., a hard drive); various user input devices, such as a mouse, a keyboard, or a microphone; and a video display system. The user devices, computers and servers described herein may be running on any one of many operating systems including, but not limited to WINDOWS, UNIX, LINUX, MAC OS, or Windows (XP, VISTA, etc.). It is contemplated, however, that any suitable operating system may be used for the present invention. The servers may be a cluster of web servers, which may each be LINUX based and supported by a load balancer that decides which of the cluster of web servers should process a request based upon the current request-load of the available server(s). Alternatively, the user devices, computers and servers described herein may be special purpose computer devices and servers designed specifically for the tasks and routines disclosed.

The user devices, computers and servers described herein may communicate via networks, including the Internet, WAN, LAN, Wi-Fi, other computer networks (now known or invented in the future), and/or any combination of the foregoing. It should be understood by those of ordinary skill in the art having the present specification, drawings, and claims before them that networks may connect the various components over any combination of wired and wireless conduits, including copper, fiber optic, microwaves, and other forms of radio frequency, electrical and/or optical communication techniques. It should also be understood that any network may be connected to any other network in a different manner. The interconnections between computers and servers in system are examples. Any device described herein may communicate with any other device via one or more networks.

The example embodiments may include additional devices and networks beyond those shown. Further, the functionality described as being performed by one device may be distributed and performed by two or more devices. Multiple devices may also be combined into a single device, which may perform the functionality of the combined devices.

The various participants and elements described herein may operate one or more computer apparatuses to facilitate the functions described herein. Any of the elements in the above-described Figures, including any servers, user devices, or databases, may use any suitable number of subsystems to facilitate the functions described herein.

Any of the software components or functions described in this application, may be implemented as software code or computer readable instructions that may be executed by at least one processor using any suitable computer language such as, for example, Java, C++, or Perl using, for example, conventional or object-oriented techniques.

The software code may be stored as a series of instructions or commands on a non-transitory computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus and may be present on or within different computational apparatuses within a system or network.

It may be understood that the present invention as described above can be implemented in the form of control logic using computer software in a modular or integrated manner. Based on the disclosure and teachings provided herein, a person of ordinary skill in the art may know and appreciate other ways and/or methods to implement the present invention using hardware, software, or a combination of hardware and software.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention. A recitation of “a”, “an” or “the” is intended to mean “one or more” unless specifically indicated to the contrary. Recitation of “and/or” is intended to represent the most inclusive sense of the term unless specifically indicated to the contrary.

One or more of the elements of the present system may be claimed as means for accomplishing a particular function. Where such means-plus-function elements are used to describe certain elements of a claimed system it will be understood by those of ordinary skill in the art having the present specification, figures and claims before them, that the corresponding structure is a general purpose computer, processor, or microprocessor (as the case may be) programmed to perform the particularly recited function using functionality found in any general purpose computer without special programming and/or by implementing one or more algorithms to achieve the recited functionality. As would be understood by those of ordinary skill in the art that algorithm may be expressed within this disclosure as a mathematical formula, a flow chart, a narrative, and/or in any other manner that provides sufficient structure for those of ordinary skill in the art to implement the recited process and its equivalents.

While the present disclosure may be embodied in many different forms, the drawings and discussion are presented with the understanding that the present disclosure is an exemplification of the principles of one or more inventions and is not intended to limit any one of the inventions to the embodiments illustrated. The attached Appendix may provide more detail regarding the operation of a payment system.

The present disclosure provides a solution to the long-felt need described above. In particular, the systems and methods described herein may be configured for improving payment systems and offers. The offers may be based on data not previously studied as the data was too large and overwhelming to be properly reviewed in a meaningful way.

Further advantages and modifications of the above described system and method will readily occur to those skilled in the art. The disclosure, in its broader aspects, is therefore not limited to the specific details, representative system and methods, and illustrative examples shown and described above. Various modifications and variations can be made to the above specification without departing from the scope or spirit of the present disclosure, and it is intended that the present disclosure covers all such modifications and variations provided they come within the scope of the following claims and their equivalents.

1. A computer system comprising:
a transaction server which receives transaction data from a purchase application for at least two different merchants through a payment network wherein the transaction data comprises indications of:
a good or a service purchased;
a price paid for the good or the service;
a quantity of the good or the service purchased;
a time of the purchase;
a location of the purchase;
a merchant selling the good or the service;
an indication of the purchaser of the good or service;
a consumer server which receives purchase data from the purchase application for at least two consumers wherein the purchase data comprises:
a good or a service purchased;
a price paid for the good or the service;
a time of the purchase;
a location of the purchase;
a merchant selling the good or the service;
an analysis server which reviews merchant data and consumer purchase data according to a learning analysis algorithm to determine purchase patterns across the merchants and across the individuals;
an offer server which matches available offers to the determined purchase patterns to find determined offers; and
a communication server which communicates the determined offers to a consumer after the consumer has completed a transaction wherein the offers are useable at a physical location or through an e-commerce sale at a point in the future.

2. The computer system of claim 1, wherein the purchase application accepts a plurality of payment devices and when a user is authorized, any of the payment devices may be used to complete a purchase.

3. The computer system of claim 1, further comprising a merchant server where a merchant that is verified receives transactions and selects offers to be communicated to the customer.

4. The computer system of claim 1, further comprising receiving a communication address from a customer and communicating the offer via the communication address.

5. The computer system of claim 1, wherein the communication address is a mobile device and the offer is communicated by a text message or SMS message.

6. The computer system of claim 1, wherein the offer is a computer link to a discount.

7. An electronic computer system for analyzing large quantities of merchant sales data and consumer purchase data using a learning algorithm to determine correlations between a first purchase at a first merchant using a first sales mode and a later purchase at another merchant using a different sales mode comprising:
a transaction server comprising a processor, a memory and an input output circuit which receives transaction data from a purchase application for at least two different merchants through a payment network wherein the transaction data comprises indications of:
a good or a service purchased;
a price paid for the good or the service;
a quantity of the good or the service purchased;
a time of the purchase;
a location of the purchase;
a merchant selling the good or the service;
an indication of the purchaser of the good or service;
a consumer server comprising a processor, a memory and an input output circuit which receives purchase data from the purchase application for at least two consumers wherein the purchase data comprises:
a good or a service purchased;
a price paid for the good or the service;
a time of the purchase;
a location of the purchase;
a merchant selling the good or the service;
an analysis server comprising a processor, a memory and an input output circuit which reviews merchant data and consumer purchase data and third party data according to a learning analysis algorithm to determine purchase patterns across the merchants and across the individuals;
an offer server comprising a processor, a memory and an input output circuit which matches available offers to the determined purchase patterns to find determined offers; and
a communication server comprising a processor, a memory and an input output circuit which communicates the determined offers to a consumer after the consumer has completed a transaction wherein the offers are useable at a physical location or through an e-commerce sale at a point in the future.

8. The computer system of claim 7, wherein the purchase application accepts a plurality of payment devices and when a user is authorized, any of the payment devices may be used to complete a purchase.

9. The computer system of claim 7, further comprising a merchant server where a merchant that is verified receives transactions and selects offers to be communicated to the customer.

10. The computer system of claim 7, further comprising receiving a communication address from a customer and communicating the offer via the communication address.

11. The computer system of claim 7, wherein the communication address is a mobile device and the offer is communicated by a text message or SMS message.

12. The computer system of claim 7, wherein the offer is a computer link to a discount.

13. . An electronic computer system for analyzing large quantities of merchant sales data and consumer purchase data using a learning algorithm to determine correlations between a first purchase at a first merchant using a first sales mode and a later purchase at another merchant using a different sales mode comprising:
a transaction server comprising a processor, a memory and an input output circuit which receives transaction data through the input output circuit from a purchase application for at least two different merchants through a payment network wherein the transaction data comprises indications of:
a good or a service purchased;
a price paid for the good or the service;
a quantity of the good or the service purchased;
a time of the purchase;
a location of the purchase;
a merchant selling the good or the service;
an indication of the purchaser of the good or service;
a consumer server comprising a processor, a memory and an input output circuit which receives purchase data through the input output circuit from the purchase application for at least two consumers wherein the purchase data comprises:
a good or a service purchased;
a price paid for the good or the service;
a time of the purchase;
a location of the purchase;
a merchant selling the good or the service;
an analysis server comprising a processor, a memory and an input output circuit wherein the processor is physically configured to reviews merchant data and consumer purchase data and third party data according to a learning analysis algorithm to determine purchase patterns across the merchants and across the individuals;
an offer server comprising a processor, a memory and an input output circuit wherein the processor is physically configured to match available offers to the determined purchase patterns to find determined offers; and
a communication server comprising a processor, a memory and an input output circuit which communicates via the input output circuit the determined offers to a consumer after the consumer has completed a transaction wherein the offers are useable at a physical location or through an e-commerce sale at a point in the future.

14. The computer system of claim 13, wherein the purchase application accepts a plurality of payment devices and when a user is authorized, any of the payment devices may be used to complete a purchase.

15. The computer system of claim 13, further comprising a merchant server where a merchant that is verified receives transactions and selects offers to be communicated to the customer.

16. The computer system of claim 13, further comprising receiving a communication address from a customer and communicating the offer via the communication address.

17. The computer system of claim 13, wherein the communication address is a mobile device and the offer is communicated by a text message or SMS message.

18. The computer system of claim 13, wherein the offer is a computer link to a discount.
